(19) United States
(12) Patent Application Publication
(10) Pub. No.: US 2009/0004499 A1
(43) Pub. Date: Jan. 1, 2009

(54) Aluminum-Based Composite Materials and Methods of Preparation Thereof

(76) Inventor: Sergei Vatchiants, Senneville (CA)

Correspondence Address: BERESKIN AND PARR, 40 KING STREET WEST, BOX 401, TORONTO, ON, M5H 3Y2, CA

(21) Appl. No.: 12/158,287

(22) PCT Filed: Sep. 1, 2006
(86) PCT No.: PCT/CA2006/001438

§ 371 Date: Jul. 22, 2008

Related U.S. Application Data
(63) Continuation of application No. 11/319,290, filed on Dec. 29, 2005.

(51) Int. Cl. B32B 15/16; B22F 3/18

(52) U.S. Cl. 428/550; 419/8

(57) ABSTRACT

There are provided multilayer composite materials comprising a first layer comprising aluminum, titanium, brass, copper, steel, or mixtures thereof; a foamable core layer comprising aluminum and a foaming agent; and a second layer comprising aluminum, titanium, brass, copper, steel, or mixtures thereof. The first and second layers can be the same or different. There is also provided a process for preparing such composite materials.

### FIELD OF THE INVENTION

The invention relates to the field of powder metallurgy. In particular, it relates to aluminum based composite materials and methods of preparation thereof.

### BACKGROUND OF THE INVENTION

Products made from aluminum foam can be used in various fields of industry. They can be used, for example, in transportation engineering and in the construction, where the following functional properties of a material are required: vibration and shock energy suppression, low weight and high strength of structural elements, fire retardantcy and ecological cleanness. From the standpoint of obtaining metal foams with a uniform structural porosity, foams obtained from aluminum are most promising. The low density of aluminum (˜2.7 g/cm³) and low melting point (˜660° C.) reduce the energy spent on its conversion of aluminum into foam and simplify the selection of blowing agents with a temperature of decomposition of 500-700° C.

The technique of aluminum powder metallurgy usually includes the following operations: mixing of the metal powders and blowing agent, preliminary consolidation of the stock (mixture), thermal compaction, deformation treatment, foaming and finishing of the semi-fabricated material into the finished product. The existing methods (U.S. Pat. No. 5,151,246, U.S. Pat. No. 5,393,485, RU2139774, RU2154548, and PCT/RU/99/00133) differ very little from each another. In some of them, hot pressing or extrusion is used. In others, hot rolling or gas static pressing. And in a third group a combination of processes. However, the qualitative parameters and output of suitable production have not substantially improved.

Oxide films of Al₂O₃ are the main factors affecting foaming and determining the physical and mechanical properties of aluminum foam. They significantly displace the solidus (Ts) and liquidus (T_{L}) curves in the high temperature region. In addition, the temperature range between them (Ts and T_{L}) is enlarged, i.e. the area of Ts-T_{L} crystallization is expanded. As a consequence of this, the viscosity of the melt increases. For this reason, superheating Tv>T_{L} is required for foaming, where Tv is the foaming temperature, i.e. the necessary temperature gradient is: ΔTg=Tv−T_{L}. The greater the temperature factor Δ T_{f}=Tv−Ts, the more depleted becomes the capacity of the alloy for simultaneous foam formation. It is for precisely this reason that aluminum foam acquires a structural porosity that is non-uniform in shape and dimensions, with characteristic partial fusions. The regulation of the gelation processes is considerably hampered.

However, the aluminum foam products proposed so far comprise several drawbacks. The sandwich composite material proposed so far often present delamination problems and due to these problems their use is considerably limited to very few applications. Moreover, the proposed composite materials do not provide enough resistance with respect to several applications such as shock resistance or impact absorbance.

### SUMMARY OF THE INVENTION

According to one aspect of the invention, there is provided a multilayer composite material comprising:
a first layer comprising aluminum, titanium, brass, copper, steel, or mixtures thereof;
a foamable core layer comprising aluminum and a foaming agent; and
a second layer comprising aluminum, titanium, brass, copper, steel, or mixtures thereof,

The first and second layers being same or different, and being connected to the foamable core layer.

According to another aspect of the invention, there is provided a multilayer composite material comprising:
a first layer comprising aluminum, titanium, brass, copper, steel, or mixtures thereof;
a foamable core layer comprising an aluminum matrix into which a foaming agent is uniformally distributed;
a second layer comprising aluminum, titanium, brass, copper, steel, or mixtures thereof,

The first and second layers being same or different, and being disposed on opposite sides of the foamable core layer, wherein the junction between the first layer and the core layer and the junction between the second layer and the core layer are monolithic junctions.

According to one aspect of the invention, there is provided a multilayer composite material comprising:
a first layer comprising aluminum, titanium, brass, copper, steel, or mixtures thereof;
a porous core layer comprising a foamed aluminum matrix, the matrix optionally comprising a reinforcing element; and
a second layer comprising aluminum, titanium, brass, copper, steel, or mixtures thereof,

The first and second layers are the same or different, and they are connected to the foamable core layer.

It was found that such composite materials demonstrated very impressive characteristics. In fact, they permitted to overcome the drawbacks of the prior art composite materials. In particular, it was found that such composite materials did not have delamination problems as encountered with the prior art products. Moreover, it was found that even when deformation such as a curve or an angle is imparted to such composite material, substantially no delamination is observed. Many non-planar forms can be given to such material for example shapes including a at least a curve portion such as a S shape, a U shape, a sinusoidal shape, shapes including an angle such as a L shape or any shape similar having an angle between 0 and 90 degrees or between 90 and 180 degrees.

According to another aspect of the present invention there is provided a method for preparing a multilayer composite material, the method comprising:
heating a mixture comprising an aluminum powder, a foaming agent, and optionally a reinforcing agent, wherein the mixture is disposed within a container and is contacting at least two opposite ends of the container or is disposed between two metal sheets, each of the sheets being contacting one of the opposite ends, the sheets being same or different and comprising aluminum, titanium, brass, copper, steel, or mixtures thereof;
compacting the mixture by hot rolling, the hot rolling being carried out by applying a pressure on at least one of the opposite ends of the container; and
removing at least a portion of the container so as to obtain a compact composite material.

According to another aspect of the present invention there is provided a method for preparing a multilayer composite material, the method comprising:
optionally introducing a metal sheet in a container;
introducing a mixture comprising an aluminum powder, a foaming agent, and optionally a reinforcing element on the metal sheet;
introducing another metal sheet on the mixture;
heating the mixture;
compacting the mixture by hot rolling, the hot rolling being carried out by applying the pressure directly on the container; and
removing at least a portion of the container so as to obtain the desired composite material.

It was found that by carrying out the methods of the present invention it was possible to obtain composite materials having superior properties as compared to the prior art products. In particular, it was observed that the products so-obtained via these methods have monolithic junctions between the core layers and the two layers that are contacting it or sandwiching it. These monolithic junctions thus permit to avoid delamination. Moreover, it was shown that the products obtained by such processes are very useful precursors for porous aluminum composite materials. It was further shown that the composite materials so-obtained can be deformed into various non-planar shapes. They can then be foamed so as to be converted into pourous compounds. Even if the so obtained products are deformed and/or foamed, no substantial delamination is observed.

In the composite materials and methods of the present invention, the steel can be chosen from mild steel, stainless steel, ordinary steel, high-strength steel, and low-carbon steel. The first layer can, for example, comprise aluminum, titanium or steel. The second layer can, for example, comprise aluminum, titanium or steel.

The composite materials can comprise several layers including several foamable layers. They can also comprise aluminum matrix layers which are non-foamable. The foamable layer(s) can be an aluminum matrix into which the foaming agent is uniformly distributed. The foaming agent can be chosen from TiH₂, CaCO₃, and, mixtures thereof. The foamable or non-foamable layer(s) can comprise a reinforcing element. The reinforcing element can present in an amount of 5 to 30 volume % as compared to the volume of aluminum powder used to prepare the reinforced layer. The reinforcing element can be chosen from dispersible powders or particles, discrete fibers, or mixtures thereof. The reinforcing element can also be a dispersible powder of a high-melting compound. Alternatively, the reinforcing element can be chosen from oxides, carbides, borides, nitrides, martensite aged steel, metallic fibers, high-modulus fibers, ceramic materials, ceramic-metallic materials, glass ceramic materials, and mixtures thereof.

In the composite materials and methods of the present invention, the foamable core layer can be an aluminum matrix into which the foaming agent and the reinforcing agent are uniformly distributed. The first and second layers can be cladded on the foamable core layer. For example, the junction between the first layer and the core layer and the junction between the second layer and the core layer can be monolithic junctions. The composite material can be a structurally monolithic material.

The composite material of claim 1, wherein the composite material further comprises two supplemental foamable layers comprising aluminum and optionally a foaming agent, one of the supplemental foamable layers is disposed on the fist layer and the other of the supplemental foamable layer is disposed on the second layer, and wherein each of the supplemental foamable layers has a layer comprising aluminum, titanium, or steel, disposed thereon.

In the composite materials and methods of the present invention, the porous core layer can have a porosity ranging from 25% to 45%.

The composite materials can further comprises two supplemental layers comprising an aluminum matrix, which is optionally porous, one of the supplemental layers is disposed on the fist layer and the other of the supplemental layer is disposed on the second layer, and wherein each of the supplemental layers has a layer comprising aluminum, titanium, brass, copper, steel, or mixtures thereof.

The composite materials can comprise at least one deformation. The composite material can be non-planar. The deformation can be a curved portion, an angle, or a compressed or expanded portion with respect to a main portion of the composite material. The deformation can also be oriented in a direction which defines an angle with respect to a plan defined by the composite material. The deformation can also be oriented in a direction which defines an angle with respect to the longitudinal axis defined by the composite material.

The composite materials can comprise at least one curved portion or a portion, different than an extremity of the material composite, defining an angle with respect to the longitudinal axis defined by the composite material.

The composite materials can comprise at least one curved portion or a portion, different than an extremity of the material composite, defining an angle with respect to a plan defined by the composite material.

For example, the composite material can sequentially comprise:
a layer comprising aluminum, titanium, brass, copper, steel, or mixtures thereof;
a layer comprising aluminum and optionally a foaming agent and/or a reinforcing element;
the first layer;
the foamable core layer;
the second layer;
another layer comprising aluminum and optionally a foaming agent and/or a reinforcing element; and
another layer comprising aluminum, titanium, brass, copper, steel, or mixtures thereof.

According to another embodiment of the present invention there is provided a composite material comprising:
a first layer comprising aluminum, titanium, brass, copper, steel, or mixtures thereof;
a foamable core layer comprising an aluminum matrix into which a foaming agent is uniformally distributed;
a second layer comprising aluminum, titanium, brass, copper, steel, or mixtures thereof,

The first and second layers are the same or different, and they are disposed on opposite sides of the foamable core layer, wherein the junction between the first layer and the core layer and the junction between the second layer and the core layer are monolithic junctions.

In the methods of the present invention, the mixture can be heated at a temperature of 500 to 600° C. The foaming agent and the reinforcing agent can be uniformly distributed within the aluminum powder. The container can be a closed volume container. The container can also be a two-part container. The container can comprise a bottom part, a top part and side parts.

For example, the obtained composite material can sequentially comprise one of the sheet, a core layer comprising an aluminum matrix comprising a foaming agent and optionally a reinforcing agent, and the other of the sheets. After hot rolling, side parts of the containers can be cut and the bottom and top parts are physically separated from the sheets.

According to another example, the mixture can be disposed within a container and the mixture is contacting at least two opposite ends of the container, and wherein after hot rolling the side parts are cut and the obtained product sequentially comprises a metal sheet comprising at least a portion of the top part, a core layer comprising an aluminum matrix comprising a foaming agent and optionally a reinforcing agent, a metal sheet comprising at least a portion of the top part.

The methods of the present invention can further comprise imparting at least one deformation to the composite material in order to obtain a non-planar composite material. The deformation can be one as previously described.

The methods can further comprise, after removing the at least portion of the container, heating, at a temperature between T_{solidus} and T_{liquidus}, the compacted composite material in order to foam the foamable core layer and convert it into a porous core layer.

According to another embodiment of the present invention there is provided a composite material comprising:
a first layer comprising aluminum, titanium, brass, copper, steel, or mixtures thereof;
a porous core layer comprising a foamed aluminum matrix, the matrix optionally comprising a reinforcing element; and
a second layer comprising aluminum, titanium, brass, copper, steel, or mixtures thereof;

The first and second layer are same or different, and they are connected to the foamable core layer.

According to another aspect of the invention, there is provided a multilayer composite material comprising:
a layer comprising aluminum, titanium, brass, copper, steel, or mixtures thereof; and
a foamable layer comprising aluminum and a foaming agent,
   wherein the junction between the two layers is monolithic.

According to another aspect of the invention, there is provided a multilayer composite material comprising:
a layer comprising aluminum, titanium, brass, copper, steel, or mixtures thereof; and

a porous aluminum layer,

wherein the junction between the two layers is monolithic.

The following formulas and processes for obtaining multilayer composite materials have been developed for structural use<M′−Al^{(a)}−M″>: not foamable, i.e., not containing a blowing agent) and for functional use<M′−Al_{f}^{(a)}−M″>. The Al_{f}^{(a)} notation provisionally signifies the structures that can be obtained. For example:<Ti−Al_{f}^{a}−St> is a sandwich cladded with Ti and St (steel), reinforced (a) and foamable (f), (f) can also designate a foamed material;

<Al−Al_{f}−Al> is a foamable sandwich (f); <Ti−Al−Ti> is a compact sandwich;

<Ti−Al^{a}−Ti> is a compact and reinforced (a) sandwich.

For example, the following composite materials have been obtained:
materials having a compact structures: <M′−Al−M″> [symbol] <M′−Al^{a}−M″> (FIG. 1), i.e. non-foamable. The materials have a high porosity and viscosity, and so belong to the category of materials for structural use;
materials having a porous structures: <M′−Al_{f}−M″> [symbol] <M′−Al_{f}^{a}M″> (FIG. 2), i.e. foamable. The materials are noted for being lightweight and having structural density, i.e. rigidity. They belong to metal foams, with the properties characteristic for them and, consequently, their spectrum of use;
materials having a compact porous structure, consisting of non-detachable layers for functional use (FIG. 3). The middle layer is reinforced aluminum foam, for example, <Ti−Al_{f}^{a}−Ti>.

These materials have a set of functional properties, specifically, capable of absorbing explosive shock energy and of protecting objects from bullet and fragmentation damage.

Reinforcement (a) can be combined (particles and fibers) or separate (particles or fibers). Both nonferrous and ferrous metals can be used as cladding layers, i.e. M′ and M″. Cladding can be done in the form of a dual-layer (M′−Al_{f}^{(a)}−M″) or single-layer (M−Al_{f}^{(a)}) sandwich. For all of the materials developed, aluminum (compact or porous) is the matrix metal or core metal. For this reason the density of them is comparatively small.

According to one aspect of the invention, there is provided a method for obtaining composite materials with a compact structure that is of the sandwich type <Metal #1−Aluminum−Metal #2>, incorporating the layer by layer packing of aluminum powder or a mixture of them (matrix) and cladding sheets made from different metals, for example titanium (Metal #1) and stainless steel (Metal #2) into a container; heating it to a temperature of 500-600° C.; hot rolling; and releasing of the rolled sandwich from the container.

The composite materials can comprise reinforcing elements, for instance dispersed particles (oxides, carbides, borides, etc.) or discrete fibers (metallic or high-modulus) or particles or fibers or combination thereof that can be introduced into the composition of the aluminum powder or mixture of them in a quantity of 5-30% of the volume.

The container can be made of metal, for instance, steel (St) or titanium (Ti) that are used as cladding layers of the sandwiches, specifically <St−Al−St>or<Ti−Al^{a}−Ti>. The container can also be manufactured from metals such as aluminum (Al) or titanium (Ti) that are the cladding layers of the sandwiches, specifically<Al−Al_{f}−Al> or <Ti−Al_{f}^{a}−Ti> types, foamed in a temperature range of<Ts−T_{L}>.

According to another aspect of the present invention there is provided a method for obtaining composite materials with a porous structure, i.e. aluminum foam of the <M′−Al_{f}−M″> sandwich type. The method comprises incorporating layer by layer packing of powder composites into a container made from metals, for instance mild steel. The powder comprises a mixture of aluminum powders (matrix) and a blowing agent such as TiH₂ or CaCO₃, and the cladding sheets are made of different metals, for example, titanium (M′) and aluminum (M″). The sandwich structure thus obtained is heated to a temperature of 500-600° C.; hot rolled to ensure that a compact structure of the formed material is obtained; and then extraction of the rolled precursor from the container is carried out. The precursor can then be foamed at a temperature range of <Ts−T_{L}>.

According to another aspect of the present invention, there is provided a method for obtaining composite materials with a compact-porous structure of the single-layer sandwich type and incorporating layer-by-layer packing of powder composites of various composition into a container made from ordinary steel of cladding and reinforcing sheets made from different metals, such as high-strength steel and titanium; heating to a temperature of 500-600° C., hot rolling to ensure that a compact structure of the formed materials is obtained; extraction of the rolled material from the container and foaming of the layer that contains the blowing agent in a temperature range of <Ts−T_{L}>.

The distribution of the multi layers can be as follows:

a) a compact layer consisting of an alloy of aluminum and fiber-reinforced glass ceramic;
b) a foamable layer, of 25-45% porosity, made up of fiber-reinforced aluminum alloy;
c) a compact layer comprising an alloy of aluminum strengthened with dispersed particles and reinforced with discrete fibers.

In the present invention, the sandwich type composite materials can be reinforced with metal sheets, titanium for example, disposed between layers. The sandwich type composite materials can be structurally monolithic materials that can be cladded with sheets of high-strength steel.

The mixing of the powder components and fibers can be done with a mixter, for example, one loaded with an alcohol-glycerin solution, ensuring explosion resistance and the yield of a uniform composition (blend).

In the present invention, single-layer or a composite material having a single cladding can be obtained. Such a composite material can be obtained by packing a powder composite and a single cladding layer into a container, thereby providing a single-layer sandwich composite material that has a compact (foamable or non-foamable) or porous (after foaming) structure and a cladding layer.

### BRIEF DESCRIPTION OF DRAWINGS

In the following drawings, which represent by way of examples only, particular embodiments of the invention;

FIG. 1(a) is a cross-section view of a multilayer composite material according to one embodiment of the present invention, which is disposed in a container used for its preparation, wherein the composite is a non-foamable sandwich type composite having the following structure <Al−Al−Ti>;

FIG. 1(b) is a cross-section view of a multilayer composite material according to another embodiment of the present invention, which is disposed in a container used for its preparation, wherein the composite is a non-foamable sandwich type composite having the following structure <Ti−Al^{a}−St>;

FIG. 2(a) is a cross-section view of a multilayer composite material according to another embodiment of the present invention, which is disposed in a container used for its preparation, wherein the composite is a foamable sandwich type composite having the following structure <Al−Al_{f}−St>;

FIG. 2(b) is a cross-section view of a multilayer composite material according to another embodiment of the present invention, which is disposed in a container used for its preparation, wherein the composite is a foamable sandwich type composite having the following structure <Ti−Al_{f}^{a}−St>;

FIG. 3 is a cross-section view of a multilayer composite material according to another embodiment of the present invention, which is disposed in a container used for its preparation, wherein the composite is a foamable sandwich type composite having the following structure <(St−Al^{a})−[Ti−Al_{f}^{a}−Ti]−(Al^{a}−St)> in which the (St−Al^{a}) and (Al^{a}−St) portions are non-foamable;

FIG. 4 is a cross-section view of a multilayer composite material according to another embodiment of the present invention, which is disposed in a container used for its preparation, wherein the composite is a foamable sandwich type composite having the following structure <Al−Al_{f}−Al>, and wherein;

FIG. 5 is a picture showing the microstructure of an aluminum-cladded sandwich composite according to another embodiment of the present invention, wherein the composite as the following structure <Ti−Al_{f}^{a}−St>, and wherein the dark colored fine inclusions represent the foaming agent uniformly distributed;

FIGS. 6(a) and 6(b) are scanograms or spectrums of composite materials of structures according to another embodiment of the present invention, wherein

FIGS. 6(a) and 6(b) respectively represent composite materials of structures <St−Al−St>and<Ti−Al−Ti>, and wherein the scanograms illustrate the element distributions (Al, Ti, Si) of these structures;

FIGS. 7(a), 7(b), and 7(c) show tomographic images of a composite material according to another embodiment of the present invention, wherein the composite material is a reinforced and foamed aluminum sandwich composite of structure <Ti−Al_{f}^{a}−Ti>, and wherein FIG. 7(a) shows a side elevation view of a the composite, FIG. 7(b) shows the structural porosity of the composite, and FIG. 7(c) shows the disposition of discrete fibers (c), which confirm uniform distribution of the pores and fibers within the bulk of the foamed sandwich composite.

### DETAILED DESCRIPTION OF THE INVENTION

The base materials were aluminum alloy powders: casting types (AA4047 etc.) and deforming types (6061, 2124, etc.). Titanium hydride (TᵢH₂.) served as the blowing agent (foaming agent). Dispersible powders of high-melting compounds (oxides, carbides, borides, nitrides, etc.) and discrete fibers made from martensite aged steel (σ_{b}=2400-3000 MPa) or screens were used as reinforcing agents. Their volumetric concentration 5-25%. The ratio of fiber length to diameter was taken in the range of t/d=70-90, which provided a maximum tensile strength (σ_{b}, MPa) close to the strength of a material reinforced with unbroken fibers. During mixing, mixtures were used in order for there to be an even distribution of the powder composite components having various sizes and densities −2.7 (Al), 3.9 (TᵢH₂) and 7.86 g/ CM³ (fibers). They do not only ensure that a uniform mix is obtained, but they also prevent dust formation and segregation of the components during the operations of loading and compacting the mixtures.

Since rolling can be a high-speed process (u=0.1-0.5 m/s) and that heating temperature sometimes does not exceed 450-550° C., the interaction of the fiber and matrix (aluminum powder) occurs on the level of atomic bonds. This means that intermediate products of the chemical reactions of the metals, which weaken the “fiber-matrix” adhesive bond, do not form on the contact boundaries (boundary surfaces).

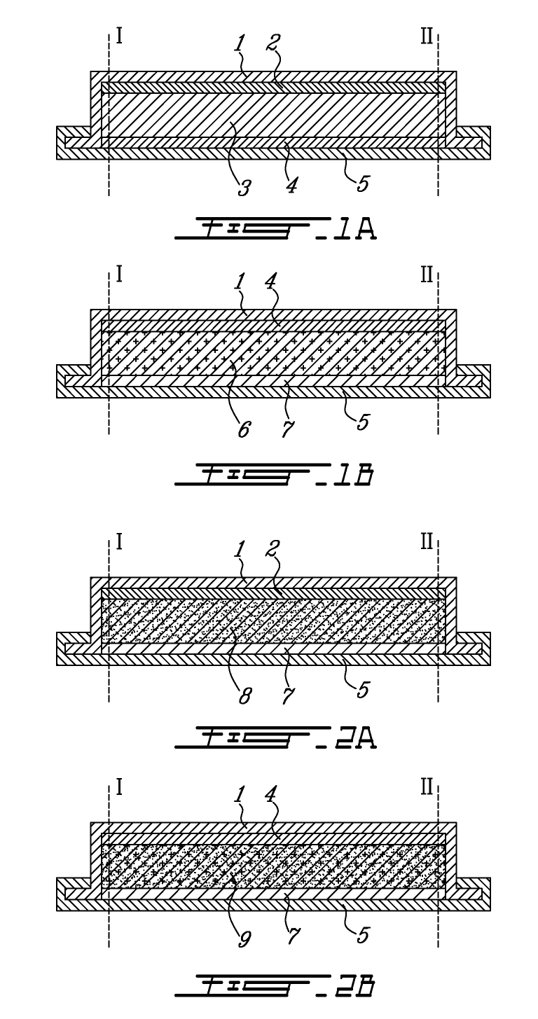

In examples 1, 2, and 3, the structures of compact porous materials are shown. If the cladding layers are comprised of a single metal, aluminum for example <Al−Al_{f}−Al>, then aluminum containers are used to prepare them (FIG. 4). If the cladding layers consist of different metals, <Al−Al−Ti> for example (FIG. 1, a), then steel containers are used. In this case, the cladding sheets are put into the containers in layers, as shown in FIGS. 1, 2, and 3. The loaded containers with powder composites are then heated to the determined temperature and rolled until a compact state is achieved, i.e. until a non-porous structure is obtained. After mechanical tooling, the roll precursor containing the blowing agent is foamed. It is possible to obtain a different profile stock by means of deformation treatment.

### Example 1

### Multilayer composite materials with a non-foamable structure (FIGS. 1(a) and 1(b)):

1-casing of container made from low-carbon steel;
2-sheet aluminum (cladding layer);
3-caked aluminum (hot rolling), matrix;
4-sheet titanium (cladding layer);
5-container lid made from low-carbon steel;
6-caked aluminum (matrix), reinforced;
7-sheet steel (cladding layer);
   lines I and II represent lines of mechanical cutting after hot rolling;
   FIG. (1a) is <Al−Al−Ti> and FIG. (1b) is <Ti−Al^{a}−St>.

### Example 2

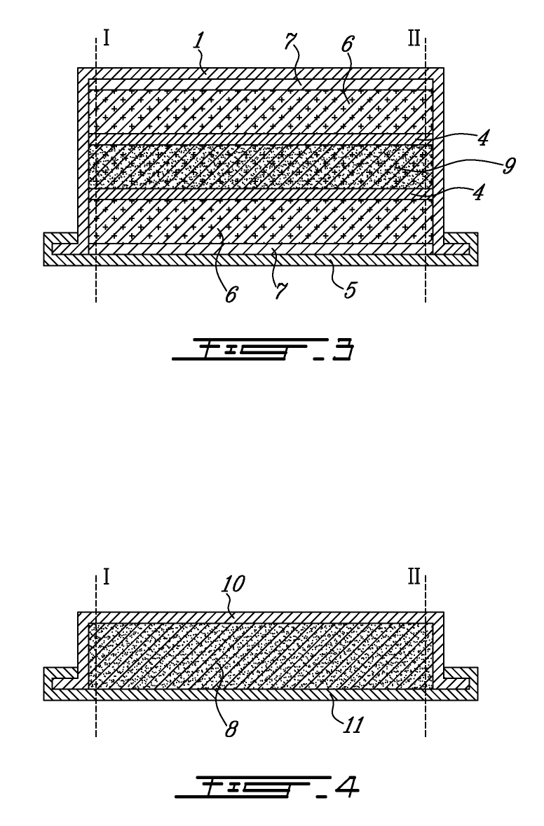

### Multilayer composite materials with a foamable structure (FIGS. 2(a) and 2(b)):

1-casing of container made from low-carbon steel;
2-sheet aluminum (cladding layer);
4-sheet titanium (cladding layer);
5-container lid made from low-carbon steel;
7-sheet steel (cladding layer);
8-foamable aluminum (matrix);
9-foamable aluminum (matrix), reinforced;
   lines I and II represent lines of mechanical cutting after hot rolling.
   FIG. (2a) is <Al−Al_{f}−St>and FIG. (2b) is <Ti−Al_{f}^{a}−St>.

### Example 3

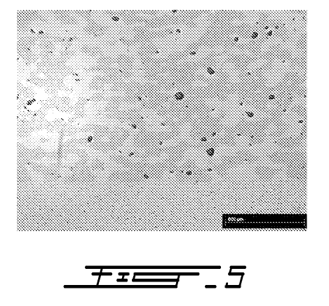

### Multilayer composite materials with a compact porous structure (FIGS. 3(a) and 3(b)):

1-casing of container made from low-carbon steel;
4-sheet titanium (reinforced layer);
5-container lid made from low-carbon steel;
6-aluminum (matrix), reinforced;
7-sheet steel (cladding layer);
9-foamable aluminum (matrix), reinforced;
   lines I-I and II-II represent lines of mechanical cutting after hot rolling.

### FIG. 3 is <(St−Al^{a})−[Ti−Al_{f}^{a}−Ti]−(Al^{a}−St)>

### Example 4

### Multilayer composite materials with a foamable structure (FIG. 4) in which the casing and the lid of the container are used as cladding layers:

10-casing of container made of aluminum;
8-foamable aluminum (matrix);
11-container lid made of aluminum;
   lines I and II represent lines of mechanical cutting after hot rolling;

### FIG. 4 is <Al−Al_{f}−Al>.

From the standpoint of technical execution, the method developed for obtaining the sandwich composite materials of the invention are fairly simple and economically efficient. It allows one to obtain, for example, sandwiches with cladding layers 0.5-10 mm or greater in thickness.

The steel container (casing 1 and lid 5) can easily be removed by means of mechanical tooling of the side edges (lines <I-II>, FIG. 1, 2, 3, 4). Scorching of the cladding layers onto the container can be eliminated, since the temperatures of the hot rolling process are comparatively low (500-600° C.). If necessary, fine layers of graphite, alumina, lime, etc. (<0.1 mm) can be dusted onto the contacting surfaces.

The problem of high-grade caking of the aluminum matrix with the cladding layers has been solved. Without resorting to expensive processes to activate the caking surface of the cladding layer, specifically gas-plasma spray-coating or chemical etching, it is sufficient to refine it by a mechanical method, for example, by sandblasting or by using an abrasive fabric.

FIG. 5 shows the microstructure of an aluminum-cladded sandwich precursor of structure <Ti−Al_{f}^{a}−St>. The structure is compact and non-porous. The distribution of TᵢH₂ is uniform (dark colored, fine inclusions). The <aluminum matrix-cladding layer > junction is monolithic (lower part of the image). The borders of the sections <−Al−Ti> [symbol] <−Al−St> are revealed by using x-ray spectral microanalysis. As it can be seen, porosity is absent from the structure shown if FIG. 5, and TᵢH₂ distribution (dark, fine inclusions) is uniform. The TᵢH₂ particles have retained their configuration, that means that they have not undergone pulverization during the rolling process. The most remarkable achievement is the monolithic bonding of all the cladded layers with the powdered aluminum, in other words, with the matrix. This is clearly evident in FIG. 5, namely, by the complete meshing of the aluminum lining (lower layer) with the matrix.

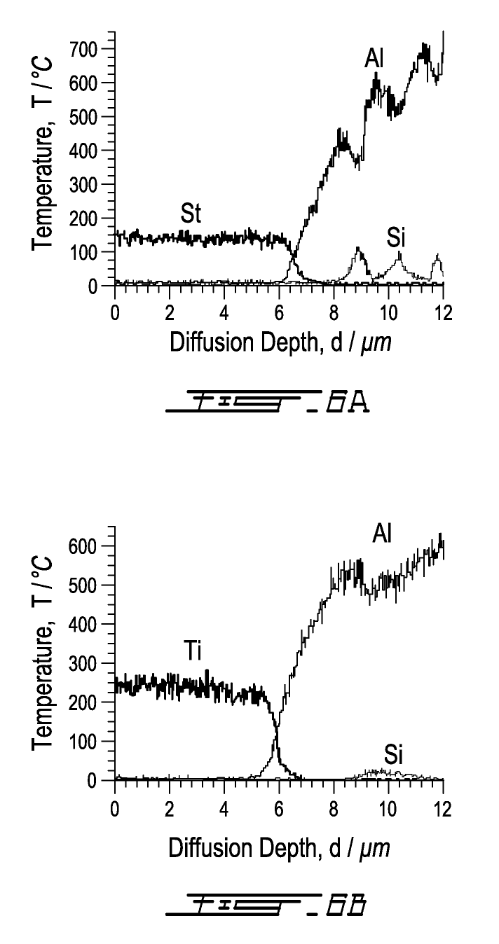

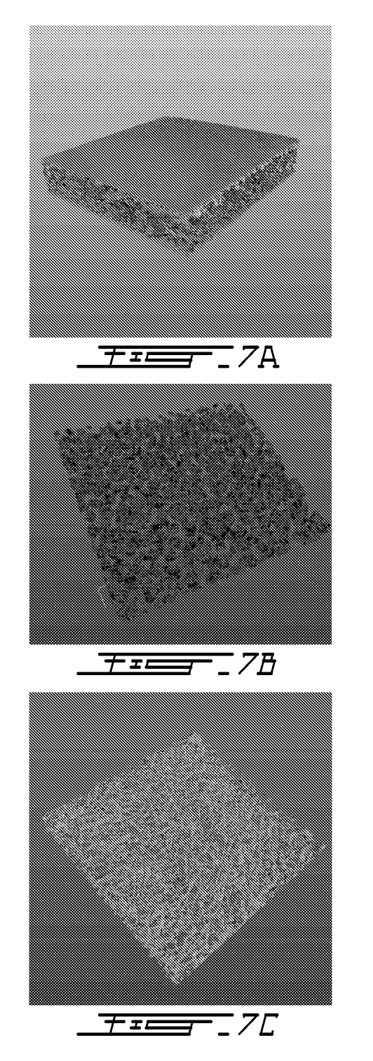

The scanograms given in FIG. 6(a, b) are evidence of mutual diffusion <Al [symbol] Ti> (a) and<Al [symbol] St>(b) which ensures the high fusion strength of the precursors-sandwiches

<Ti−Al−Ti> and <St−Al−St>. The depth of the diffusion layer<−Al−Ti> (a) is greater than the layer<−Al−St>(b). This can be explained by the <Ti−Al> status, that is, by the better metallic compatibility of Ti and Al, than St and Al. Thus, the solubility of Al in α−Ti at 600° C. is 7.5% by mass. FIG. 7 shows a tomographic image of an aluminum foam sandwich (a), structural porosity (b) and the disposition of discrete fibers (c), which confirm uniform distribution of the pores and fibers within the bulk of the foamed sandwich <Ti−Al_{f}^{a}−Ti>.

Firing range tests of the compact porous material 25-35 mm in thickness showed positive results.

The layer absorbing the impact can be manufactured from a ceramic-metallic material (cermet) containing a glass ceramic in a composition of aluminum powder and filamentary fibers. The glass ceramic, or glass melt, crystallizes during the process of hot rolling and subsequent cooling, acquiring a high rigidity approaching that of sital.

The middle layer or core layer, the foamed one, can be strengthened enough to maximally absorb the energy of an impact or explosion. The layer can be reinforced with filamentary fibers 5-10% of volume. Optimal porosity can be 25-45%.

The support layer can be manufactured out of ceramic metals. The matrix can be reinforced with dispersed particles and filamentary fibers (10-25% of volume) that provide the high strength and viscoelastic properties of the layer. It was thus shown that it was possible to obtain laminate materials such as sandwiches and cladded sheets made out of aluminum, titanium, and steel or combination of such. Also, powdered aluminum alloys can easily be reinforced with dispersed particles and discrete fibers.

The uniqueness of these properties can be due to the fact that the region of aluminum alloy crystallization, that is, of the solidus (Ts)-liquidus (T_{L}) boundary, is situated in the comparatively low temperature range of 570-600° C. Consequently, the processes of powder composite consolidation on an aluminum base takes place during active caking conditions. The presence of a low-temperature eutectic state (˜577° C.), i.e., a liquid-phase wetting state, makes it possible to successfully carry out the cladding and reinforcing processes, at the same time retaining the structural integrity of the aluminum foam.

It was also shown that it is possible to obtain aluminum-based composite materials with a compact porous structure and which are distinguished by their functional properties. Moreover, these metal foams and highly porous structures, can be modified into composite materials with a wide spectrum of properties. This was achieved by cladding with various materials, and also by reinforcing them with high-melting particles and filamentary fibers.

Mixtures comprising aluminum powders, a blowing agent, and reinforcing agents in the form of fibers and particles, were pre-compacted, then subjected to hot rolling in metal containers and then foamed to obtain a sandwich-type composite material. Without using a blowing agent and, consequently, eliminating the foaming operation. The methods of the present invention can thus also permit to obtain laminated materials with a compact, i.e. non-porous structure.

The person skilled in the art would also recognize that various modifications, adaptations, and variations may be brought to the previously presented preferred embodiments without departing from the scope of the following claims.

1. A multilayer composite material comprising:
a first layer comprising aluminum, titanium, brass, copper, steel, or mixtures thereof;
a foamable core layer comprising aluminum and a foaming agent; and
a second layer comprising aluminum, titanium, brass, copper, steel, or mixtures thereof,
said first and second layers being same or different, and being connected to said foamable core layer.

2. The composite material of claim 1, wherein said composite material sequentially comprises:
a layer comprising aluminum, titanium, brass, copper, steel, or mixtures thereof;
a layer comprising aluminum and optionally a foaming agent and/or a reinforcing element;
said first layer;
said foamable core layer;
said second layer;
another layer comprising aluminum and optionally a foaming agent and/or a reinforcing element; and
another layer comprising aluminum, titanium, brass, copper, steel, or mixtures thereof.

3. (canceled)

4. (canceled)

5. (canceled)

6. (canceled)

7. The composite material of claim 1, wherein said foamable core layer is an aluminum matrix into which the foaming agent is uniformly distributed.

8. (canceled)

9. The composite material of claim 1, wherein said foamable core layer comprises a reinforcing element.

10. The composite material of claim 9, wherein said reinforcing element is present in said foamable core layer in an amount of 5 to 30 volume % as compared to the volume of aluminum powder used to prepare the core layer.

11. (canceled)

12. (canceled)

13. (canceled)

14. The composite material of claim 9, wherein said foamable core layer is an aluminum matrix into which the foaming agent and the reinforcing agent are uniformly distributed.

15. (canceled)

16. (canceled)

17. (canceled)

18. The composite material of claim 1, wherein said first and second layers are cladded on said foamable core layer.

19. The composite material of claim 1, wherein the junction between said first layer and said core layer and the junction between said second layer and said core layer are monolithic junctions.

20. The composite material of claim 1, wherein the composite material is a structurally monolithic material.

21. The composite material of claim 1, wherein said first and second layers comprise aluminum.

22. The composite material of claim 1, wherein said composite material further comprises two supplemental foamable layers comprising aluminum and optionally a foaming agent, one of said supplemental foamable layers is disposed on said fist layer and the other of said supplemental foamable layer is disposed on said second layer, and wherein each of said supplemental foamable layers has a layer comprising aluminum, titanium, or steel, disposed thereon.

23. (canceled)

24. A multilayer composite material comprising:
a first layer comprising aluminum, titanium, brass, copper, steel, or mixtures thereof;
a porous core layer comprising a foamed aluminum matrix, said matrix optionally comprising a reinforcing element; and
a second layer comprising aluminum, titanium, brass, copper, steel, or mixtures thereof;
said first and second layers being same or different, and being connected to said foamable core layer.

25. The composite material of claim 24, wherein said composite material sequentially comprises:
a layer comprising aluminum, titanium, brass, copper, steel, or mixtures thereof;
a layer comprising an aluminum matrix, said matrix being optionally porous and optionally comprising a reinforcing element;
said first layer;
said porous core layer;
said second layer;
another layer comprising an aluminum matrix, said matrix being optionally porous and optionally comprising a reinforcing element; and
another layer comprising aluminum, titanium, brass, copper, steel, or mixtures thereof.

26. The composite material of claim 25, wherein said porous core layer has a porosity ranging from 25% to 45%.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. The composite material of claim 24, wherein said first and second layers are cladded on said foamable core layer.

40. The composite material of claim 24, wherein the junction between said first layer and said core layer and the junction between said second layer and said core layer are monolithic junctions.

41. The composite material of claim 24, wherein the composite material is a structurally monolithic material.

42. The composite material of claim 24, wherein said first and second layers comprise aluminum.

43. (canceled)

44. The composite material of claim 1, wherein said composite material comprises at least one deformation.

45. (canceled)

46. (canceled)

47. (canceled)

48. (canceled)

49. (canceled)

50. (canceled)

51. A method for preparing a multilayer composite material, said method comprising:
heating a mixture comprising an aluminum powder, a foaming agent, and optionally a reinforcing agent, wherein said mixture is disposed within a container and is contacting at least two opposite ends of said container or is disposed between two metal sheets, each of said sheets being contacting one of said opposite ends, said sheets being same or different and comprising aluminum, titanium, brass, copper, steel, or mixtures thereof;
compacting the mixture by hot rolling, said hot rolling being carried out by applying a pressure on at least one of said opposite ends of the container; and
removing at least a portion of said container so as to obtain a compact composite material.

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)
